(19) United States
(12) Patent Application Publication
(10) Pub. No.: US 2023/0194362 A1
(43) Pub. Date: Jun. 22, 2023

(54) RECHARGEABLE ELECTRIC FOOD THERMOMETER AND CHARGING DEVICE

(71) Applicant: Vorwerk & Co. Interholding GmbH, Wuppertal (DE)

(72) Inventors: Matthias Stein, Mülheim an der Ruhr (DE); Fabian Schulz, Oberhausen (DE); Mirco Serndt, Velbert (DE)

(21) Appl. No.: 18/075,972

(22) Filed: Dec. 6, 2022

(30) Foreign Application Priority Data
Dec. 16, 2021 (EP) 21214995.9

(51) Int. Cl. G01K 13/00; G01K 1/14; H02J 50/10; H02J 7/00; H02J 50/40; A47J 43/07

(52) U.S. Cl. CPC G01K 13/00; G01K 1/14; H02J 50/10; H02J 7/0044; H02J 50/402; A47J 43/0716; G01K 2207/06

(57) ABSTRACT

The present disclosure relates to a food thermometer with a temperature sensor, with a rechargeable battery, with a coil through which the battery can be inductively charged. The food thermometer may comprise an elongated, liquid-tight container having an opening at an end face, wherein the opening is closed in a liquid-tight manner by a cap. The disclosure further relates to a charger for the food thermometer. The charger may be a food processor.

### CROSS-REFERENCE TO RELATED APPLICATION

This application claims priority to European Application No. 21214995.9, filed Dec. 16, 2021, which application is hereby incorporated in its entirety here in.

### FIELD OF THE DISCLOSURE

The present disclosure relates to a rechargeable electric food thermometer and a charging device.

### BACKGROUND

A food is a nourishment prepared from one or more foodstuffs. The preparation may comprise warming or heating. Examples of foodstuffs that can be prepared by warming or heating are meat, vegetables, or dough for baked goods.

A food thermometer is a temperature measuring device designed and suitable for measuring temperatures in a food product or foodstuff during its preparation. A food thermometer can therefore measure temperatures that may occur during the preparation of a food. Temperatures that significantly deviate from this cannot be measured. In addition, a food thermometer can withstand the surrounding conditions that can occur during the preparation of a food.

As a rule, temperatures of less than 200° C. are reached when preparing a food. However, temperatures of 350° C. can also be reached, for example for baking a pizza. Temperatures of more than 350° C. are generally not exceeded. A food thermometer in the sense of the present disclosure is therefore configured such that temperatures above 400° C., preferably above 300° C., particularly preferably above 250° C., can no longer be measured. In principle, the food thermometer is configured such that this can be used in a conventional baking oven, i.e. at temperatures of up to 250° C. or 220° C.

### SUMMARY

A food thermometer may be intended and suitable to be pierced (inserted) into a food to be able to measure a temperature inside the food. For this purpose, a food thermometer may comprise an elongated probe having a pointed end or at least a very thin end to enable the probe to be pierced into relatively solid nourishment such as meat. The probe comprises a sensor by means of which a temperature can be measured. A food thermometer may comprise a handle portion that is not intended to be inserted into the food. The handle portion may be grasped by a user to allow the food thermometer to be withdrawn (removed) from a nourishment or food. The handle portion may also comprise a sensor by means of which a temperature can be measured. The surrounding temperature outside a nourishment or food can then also be measured.

A food thermometer in the sense of the present disclosure is an electrical food thermometer if it requires electrical power for its operation. Thus, an electric food thermometer may comprise a battery or may be connected to an external electrical power source to be supplied with electric power.

The present disclosure aims to provide a convenient way to charge the battery of an electric food thermometer.

A food thermometer with a temperature sensor, with a rechargeable battery, and with a coil through which the battery can be inductively charged serves to solve the task.

A battery is a storage of electrical energy. The storage can store electrical energy in an electrochemical way.

A coil is a wound electrical conductor. The electrical conductor can be wound spirally in only one plane. In this case, the coil has a very flat design in order to occupy only small installation space. However, a very flat design can also be realized in that the electrical conductor runs in no more than five superimposed planes or no more than three superimposed planes.

The battery can be charged by the coil and electromagnetic induction, i.e., by the generation of an electric field at the coil due to a change in a magnetic flux. The electric field is generated by another coil, which is therefore also called the transmitting coil.

The food thermometer may comprise an elongated, liquid-tight container. Thus, the container is several times longer than it is tall and wide. The container may be at least three or five times as long as it is high or wide.

To ensure that the container is particularly reliably liquid-tight, it is preferably manufactured in one piece. This means that several parts are not first manufactured separately from one another and then joined together to form the container.

The opening of the container is located at an end face. The opening is sealed in a liquid-tight manner by a cap.

To ensure that the cap is particularly reliably liquid-tight, it is preferably manufactured in one piece. This means that several parts are not first manufactured separately from one another and then joined together to form the cap.

The cap is preferably connected to the container in an integrally bonded and/or non-positive manner.

An outer diameter of the cap can fit closely against an inner diameter of the container with a pressure. There is then an interference fit between the cap and the container. Conversely, an inner diameter of the cap can fit closely against an outer diameter of the container with a pressure. However, this can be less preferable, because the material of the container is usually mechanically more stable than the material of the cap. In both cases, the cap is connected to the container in a non-positive manner. A particularly tight connection can thus be achieved reliably and durably.

An outer diameter of the cap may be bonded (glued) to an inner diameter of the container.

Conversely, an inner diameter of the cap can be bonded to an outer diameter of the container. In both cases, the connection is a material bond. In this way, a particularly reliable and durable tight connection can be achieved between the cap and the container.

The coil is advantageously arranged at the bottom of the cap. The coil can then be coupled inductively with another coil for charging the battery of the food thermometer particularly easily.

The container preferably consists of metal. Aluminum is a particularly suitable metal because it is a good conductor of heat and resistant to oxidation. However, a stainless steel may also be provided as the metal.

The cap preferably consists of a plastic, which is preferably heat resistant up to 200° C. or 220° C. The cap can then be used particularly well as a handle due to its low heat capacity and relatively low thermal conductivity.

The food thermometer can have a pointed end, i.e. a tip on an end face. The food thermometer can then be inserted into a food particularly easily.

The battery can be located at the pointed end. This protects the battery particularly well from excessive heat during preparation of a food when the tip of the food thermometer is inserted into a food.

At the pointed end of the food thermometer there is preferably a temperature sensor. Advantageously, the temperature inside a food can then be measured in order to produce a food in an optimized manner.

Preferably, a temperature sensor is present in the half of the food thermometer opposite the pointed end. Then, alternatively or additionally, the surrounding temperature outside of the food can be measured. A food can be prepared in a further improved manner if both the temperature inside the food and the surrounding temperature outside the food can be measured.

The coil may be connected to an AC/DC converter via an electrical conductor. The battery may be connected to the AC/DC converter by an electrical conductor. The AC/DC converter is a component that converts alternating current to direct current. The battery can then be charged with direct current. The AC/DC converter is basically arranged between the coil and the battery to be able to minimize the installation space.

The disclosure also relates to a charger for the food thermometer. The charger comprises a coil for inductively charging the food thermometer. The charger comprises an elongated receptacle for receiving and charging the food thermometer. Alternatively or complementarily, the charger comprises a holder by which the food thermometer can be held for charging. In particular, the thermometer can be suspended or magnetically held in the holder.

Elongated receptacle means a space intended and suitable for storing the food thermometer. The receptacle is bounded by walls. The receptacle comprises an opening through which the food thermometer can be placed in the receptacle. If the food thermometer is located in the space, the food thermometer cannot accidentally fall out of the receptacle laterally. The receptacle is elongated and therefore longer than it is wide and high. The length, width and height of the receptacle basically correspond to the length, width and height of the food thermometer. The food thermometer can therefore hardly move within the receptacle. By “hardly move” is meant that the food thermometer can move a maximum of a few millimeters, for example no more than 5 mm. The receptacle may be realized by a recess in a kitchen appliance.

Holder means a device that can hold the food thermometer without having to limit a space by walls that are of similar length as the food thermometer. The dimensions of a holder can therefore advantageously be many times smaller than the dimensions of the food thermometer. In particular, the food thermometer can be suspended (hooked) into the then mechanically acting holder and then remains in the holder due to gravity. To achieve this particularly reliably, the mechanically acting holder preferably holds the area of the food thermometer that serves as a handle. The holder then grasps, for example, the area serving as a handle, such as the aforementioned cap, but not another area of the food thermometer. The food thermometer held by the holder basically protrudes from the holder in the direction of the ground.

The holder may alternatively be a magnetic holder that can indirectly or directly magnetically hold the food thermometer.

Preferably, the food thermometer can be received by the receptacle or held by the holder only in such a way that the battery of the food thermometer can be charged. Thus, the shape of the food thermometer and the shape of the receptacle or holder adapted thereto ensure that the food thermometer is received or held in a defined manner. It is thus avoided that the food thermometer can be brought into the receptacle or held by the holder in such a way that the battery of the food thermometer cannot be charged.

The charger may be a charging tray with an elongated container. The charging tray then has the shape of a relatively flat elongated container that is open at the top. There may be a lid for the charging tray.

Alternatively, the charger may be elongated and tubular, wherein one end of the tube is closed and the opposite end is open. There may be a closure for the open end. However, the charging tray is preferred. The food thermometer can be placed in and removed more quickly in the charging tray.

The charging tray may comprise a coil in an end face of the elongated container for charging the food thermometer. Then a coil of the food thermometer can be arranged at an end face, which is particularly advantageous in order to be able to obtain a tight, inductively chargeable food thermometer with a small installation space.

The charging tray can comprise a battery for charging the food thermometer. The charging tray can then be temporarily used independently of an external power source.

The charging tray may comprise a coil for inductive charging of the battery of the charging tray. The coil may be arranged in the bottom of the container of the charging tray so that conventional inductive chargers, such as inductive charging mats, can be used for charging the battery of the charger.

The charger may be a kitchen appliance, such as a food processor. A kitchen appliance is an appliance that is designed and suitable for preparing a food. Such a kitchen appliance then additionally performs the function of charging the battery of the food thermometer. Thus, the space required for a charger is minimized. A food processor comprises a stand part, a vessel insertable into the stand part, a mixing and/or cutting tool for mixing and/or chopping a food in the vessel, and a motor as a drive for the mixing and/or cutting tool.

The kitchen appliance may charge the food thermometer indirectly or directly. The kitchen appliance may comprise, for example, a recess for a battery-powered charger or for the food thermometer. When the charger, such as a charging tray, is inserted into the recess, the battery of the charger is charged via electrical contacts or a via coil in the kitchen appliance. The charger can then charge an inductively connected food thermometer. In this way, the kitchen appliance can indirectly charge the food thermometer. The battery-powered charger may be the aforementioned charging tray.

The recess in the kitchen appliance may be present in a side wall of the kitchen appliance to protect particularly well from contamination. The recess may be present on an upper side of the kitchen appliance to make the food thermometer particularly easy to grasp.

The kitchen appliance may be, for example, an oven, a microwave oven, a coffee maker or a microwave oven.

The present disclosure also relates to a food processor with a holder for the food thermometer and/or a recess for a charger or for the food thermometer, so as to be able to store a food thermometer suitably. The food processor is then only used for storing, but not for charging the battery of the food thermometer.

Brief Descriptions of the Drawings

Embodiments of the present disclosure are explained in more detail below with reference to figures.

They show:

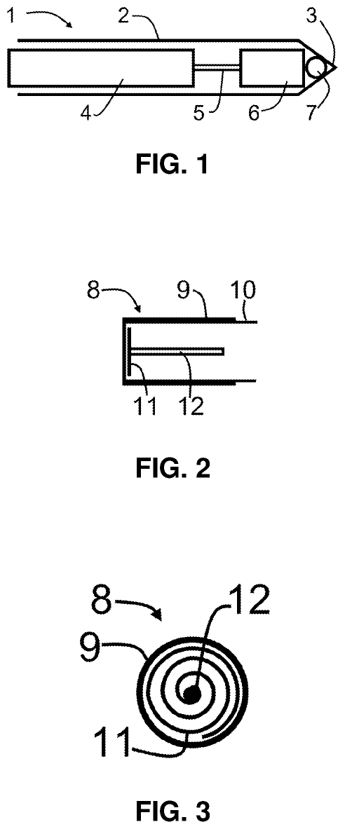

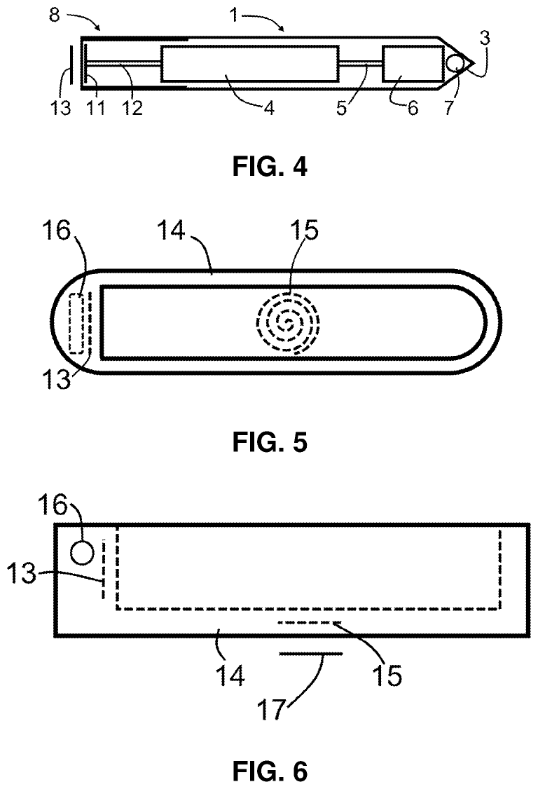

FIG. 1: Cross section through a thermometer front part; FIG. 2: Cross section through a thermometer cap; FIG. 3: Top view on thermometer cap; FIG. 4: Cross section through food thermometer; FIG. 5: Top view on charging tray;

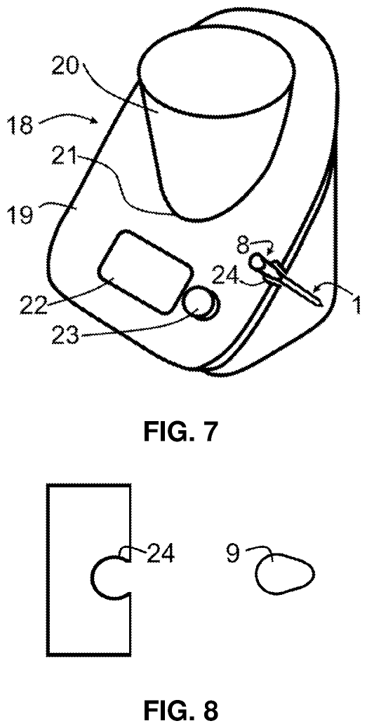

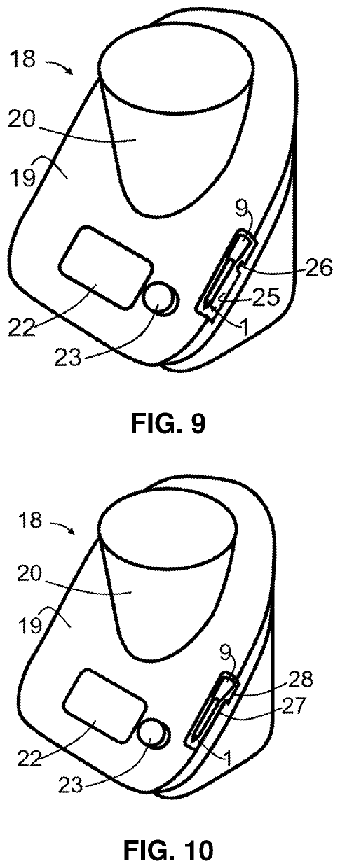

FIG. 6: Cross section through charging tray; FIG. 7: Food processor with thermometer holder; FIG. 8: Top view on thermometer holder; FIG. 9: Food processor with recess for food thermometer; FIG. 10: Food processor with recess for food thermometer;

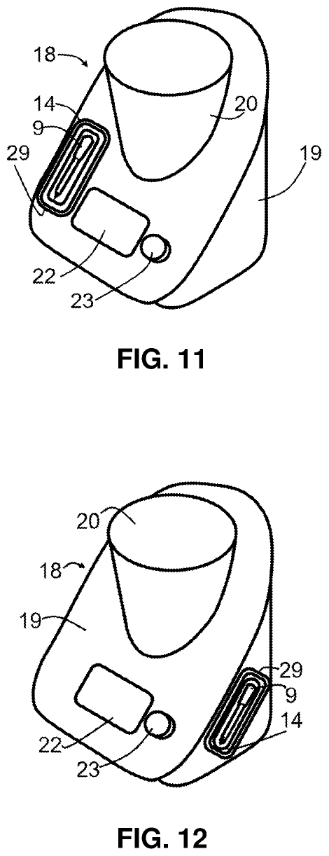

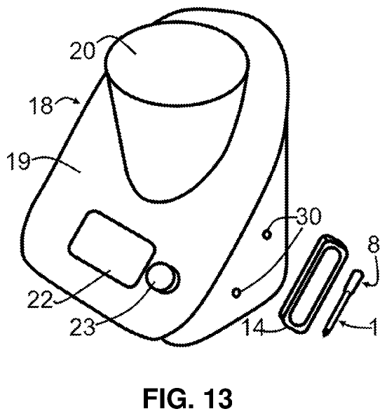

FIG. 11: Food processor with recess for charging tray; FIG. 12: Food processor with side recess for charging tray; FIG. 13: Food processor with magnetic holder.

### DETAILED DESCRIPTION

FIG. 1 shows a front part 1 of a food thermometer. The front part 1 is shown in cross-section. The front part 1 comprises a tubular section 2, which is tightly closed at one end by a tip 3. The tubular section 2 and the tip 3 may have been produced from a single piece to ensure a tight connection between the tubular section 2 and the tip 3. However, it is also possible that the tubular section 2 and the tip 3 have first been produced separately. Subsequently, the tubular section 2 may have been materially bonded to the tip 2. The front part 1 is thus an elongated, tight container with an opening at one end face.

The tubular section 2 and the tip 3 may consist of a material with good thermal conductivity, such as metal. The tubular section 2 and the tip 3 may, in the case of metal, have been joined by welding or soldering or brazing following their producing. The tubular section 2 and the tip 3 may consist of a ceramic, for example.

Within the tubular section 2 there is a circuit board 4, which is connected to a rechargeable battery 6 via an electrical line 5. The circuit board 4 may be equipped with a radio unit to be able to send measured temperatures wirelessly. The circuit board may be equipped with an AC/DC converter that converts alternating current to direct current. The circuit board 4 may be equipped with an integrated circuit or with a microcontroller which can control the operation of the food thermometer.

The temperatures inside the food during its producing by heat supply are usually lower than outside the food. The battery 6 is located at the tip 3 to be protected from heat during operation. The battery 6 is protected from heat because the tip 3 is intended and suitable to be inserted into a food.

Inside the front part there is at least one temperature sensor 7, which is electrically conductively connected to the circuit board 4. The temperature sensor 7 may conveniently be located within the tip 3. It is then ensured that the temperature inside a food can be measured during its producing.

In FIG. 2, an end piece 8 of the food thermometer is shown in cross-section. The end piece 8 comprises a cap 9. The outer diameter 10 of the cap 9 is reduced at the opening of the cap 9. This may have been achieved by a reduced wall thickness. The material of the cap 9 preferably consists of a poorly heat conducting material such as plastic. The material of the cap 9 preferably consists of a non-metallic material to avoid electromagnetic shielding. This is another reason why plastic is a suitable material. The end piece 8 is then particularly suitable to be used as a handle. The material of the cap 9 may consist of polyetheretherketone (PEEK), for example. Alternatively, a ceramic material is possible.

One or more further temperature sensors may also be present to measure temperatures inside and outside a food. At least one temperature sensor is therefore preferably arranged in the upper half of the food thermometer, which is opposite the tip 3.

A coil 11 is present in the bottom of the cap 8. The coil 11 is connected to an electrical conductor 12.

FIG. 3 shows a top view of the end piece 8 into the cap 9. The coil 11 and the electrical conductor 12 can therefore be seen. It can be seen that the electrical conductor 12 terminates in the center of the winding of the coil 11. The coil 11 may have been bonded to the bottom of the cap 9. The coil 11 may have been embedded into the material of the cap 9. The coil 11 may have been applied to a non-metallic substrate to avoid electromagnetic shielding.

The end piece 8 serves as a closure for the front part 1. In a first step, the electrical conductor 12 is suitably connected to the circuit board 4 for closing the front part 1, usually by soldering or brazing. For example, a clamp connection is alternatively possible. Thanks to the reduced diameter 10, this area of the end piece 8 can be pushed into the tubular section 2, which is done following the first step. Moreover, the area of the reduced diameter 10 is firmly and tightly connected to the tubular section 2 by clamping action and/or bonding. Preferably, therefore, there is an interference fit between the reduced diameter 10 and the inner diameter of the tubular section 2 to ensure a particularly tight connection. At least, it is preferably a transition fit. Subsequently, the final assembly is completed and the food thermometer shown in cross-section in FIG. 4 is present. Since the coil 11 serves as a receiving coil, the battery 6 of the food thermometer can be inductively charged by an external transmitting coil 13. Induced electric current is passed from the receiving coil 11 to the AC/DC converter via the electrical conductor 12. Direct electrical current is then conducted to the battery 6 via the electrical conductor 5. The battery 6 can be charged in this way.

The coil 11 serving as the receiver does not necessarily have to be arranged in or at the bottom of the cap 9. It can also be arranged differently so that inductive contact with a transmitting coil 13 is possible. However, the arrangement in the bottom of the cap 11 is particularly advantageous, since it allows important properties of the food thermometer to be realized: The coil 11 can be reached inductively very well and reliably. Charging can then be performed with high efficiency. A very tight housing can be created in order to protect the inside of the food thermometer very well from harmful external influences, such as can occur during the preparation of a food.

In order to charge the food thermometer, a charging tray may be provided. An example of a charging tray is shown in FIG. 5 in a top view into the charging tray, and in FIG. 6 in cross-section. The charging tray comprises a container 14 having an elongated interior, thus having long sides, and short sides in comparison thereto. The interior of the container 14 is sized to allow the food thermometer to be placed within the container 14. Preferably, the interior of the container 14 is adapted to the shape of the food thermometer such that the food thermometer can only be placed into the interior space in a predetermined direction. The predetermined direction is then such that a transmitting coil 13 of the charging tray arranged at the end face is adjacent to the receiving coil 11 of the food thermometer. For example, in this end face, a rechargeable battery 16 may be provided via which electrical energy may be provided for charging the food thermometer. If the coil 11 in the bottom of the cap 9 is arranged in a plane parallel to the bottom, no particular direction of rotation is required for charging the food thermometer.

Preferably, a coil 15 may be provided in the bottom of the charging tray, via which the battery 16 of the charging tray can be charged. In this embodiment, conventional inductive chargers with a transmitting coil 17 may be used to charge the battery 16. The charging tray may comprise an AC/DC converter to initially convert induced alternating current to direct current. By means of the direct current, the battery 16 can then be charged.

The container 14 of the charging tray may be elongated like the interior. The container 14 then has opposing long sides and opposing short sides relative thereto.

In FIG. 7, a food processor 18 is shown. The food processor 18 comprises a stand part 19 and a vessel 20. A food can be prepared in the vessel 20. The vessel 20 is inserted into a recess 21 of the stand part 19. The vessel 20 can be removed from the stand part 19. A mixing and/or cutting tool is located in the bottom of the vessel 20. The mixing and/or cutting tool can be driven by a motor located in the stand part 19. In particular, the mixing and/or cutting tool may be driven at rotational speeds of more than 5000 revolutions per minute, preferably of more than 10000 revolutions per minute.

The food processor 18 may comprise a heating device by means of which the container 20 can be heated. The food processor 18 may comprise a scale by means of which the weight of a food contained in the vessel 20 can be weighed. The food processor 18 may comprise a display 22 which may be a touch-sensitive display. The food processor 18 may then be operated via the display 22. The food processor 18 may comprise one or more mechanical control elements 23. A control element 23 may be a rotatable knob and/or pressable knob to operate the food processor 18.

The food processor 18 may comprise a holder 24 for the food thermometer. The holder 24 may be a part-circular opening 24 in a protruding edge portion of the food processor 18. If the end piece 8 widens towards its free end, the food thermometer can be suspended in the holder 24 as shown in FIG. 7. Holder 24 and/or end piece 8 are then preferably shaped such that the food thermometer is always suspended in the same manner. The end piece 8 may therefore be, for example, drop-shaped when viewed in top view as shown in part in FIG. 8. The opening 24 may be adapted to this drop shape. In particular in this embodiment of the disclosure, a transmitting coil 13 may be provided in the food processor 18 through which the battery of the food thermometer may be charged. If the food thermometer can only be suspended always in the same manner, it can be ensured in an improved manner that a transmitting coil 13 of the food processor can be inductively coupled to a receiving coil 11 of the food thermometer.

The holder 24 is oriented such that the food thermometer can be held in the holder 24 by means of gravity. As shown, the food thermometer may make an angle less than 90° with the ground when the associated surface of the food processor 18 is not parallel to the ground. The end portion 8 of the food thermometer serving as a handle may protrude with respect to the surface comprising the holder 24, as shown in FIG. 7, so as to be particularly easy to grasp. This is particularly true when the corresponding surface is already a surface inclined relative to the ground as shown in FIG. 7. In the suspended state, the food thermometer can enclose a right angle with this inclined surface in order to be easily accessible.

In FIG. 9, a food processor 18 is shown with a side recess 25 in the inclined surface of the food processor 18. The recess 25 is sized to allow the food thermometer to be placed within the recess 25. Preferably, the recess 25 is open at the side so that the food thermometer can be easily grasped. A web 26 of the food processor, projecting upwardly laterally from the recess 25, may be present to protect the food thermometer from falling out laterally. The web 26 is preferably disposed as shown at the transition region between the cap 9 and the front portion 1 of the food thermometer, to indicate an insertion direction of the food thermometer. Adjacent to the end face of the cap 9, a transmitting coil may then be integrated in the food processor 18 via which the battery of the food thermometer can be inductively charged.

For example, the web 26 and/or wall areas of the recess 25 may be adapted to the shape of the food thermometer in such a way that the food thermometer can only be inserted into the recess 25 in a predetermined direction. This can ensure that the food thermometer can only be inserted into the recess 25 in such a way that the battery of the food thermometer is then inductively charged. The food thermometer may have a groove, for example a circumferential groove, for example in the region of the cap 9 or adjacent to the cap 9, in which, for example, the web 26 and/or projections in the wall region of the recess 25 engage when the food thermometer is inserted into the recess 25. This is one way to ensure that the food thermometer can only be inserted into the recess 25 such that the battery of the food thermometer battery is inductively charged.

For example, there may be a permanent magnet behind a wall portion of the recess 25 by which the food thermometer inserted into the recess 25 is magnetically held. A web 26 or other holding means can then be omitted without difficulty. The magnet can be used to specify a direction for inserting the food thermometer into the recess.

Instead of a web, the food thermometer may also be protected from falling out of the recess by a wall section 27 shown in FIG. 10. A side opening 28 may be provided at the height of the cap 9 to facilitate removal of the food thermometer. It may be that the side opening 28 is mandatory due to a widening of the cap 9 to allow the food thermometer to be inserted into the recess. This may also define the direction that is mandatory for inserting the food thermometer into the recess.

The food processor 18 may comprise a recess 29, as shown in FIG. 11, into which the charging tray comprising the container 14 may be inserted. A transmitting coil may be provided in the bottom of the recess 29, for example, such that the battery of the charging tray may be charged thereby. The recess 29 may have a side opening for easy removal of the charging tray from the recess 29. The container 14 of a charging tray inserted into the recess 29 may protrude from the adjacent surface of the stand part 19 to allow the charging tray to be easily grasped for removal.

A recess 29 for the charging tray can alternatively be provided in a side wall of the stand part 19 of the food processor 18. In this way, the charging tray is better protected from contamination. An example of such an arrangement is shown in FIG. 12.

In FIG. 13, the case of a magnetic holder on a side wall of the food processor 18 is shown. The magnetic holder comprises, for example, as shown, two permanent magnets 30. Corresponding permanent magnets may be embedded in the housing 14 of the charging tray, or platelets of ferromagnetic material, so that the housing 14 can be magnetically held at the side wall of the food processor 18. A coil may be disposed in the side wall between the two permanent magnets 30 such that the battery of the charging tray may be charged when the charging tray is magnetically held. The housing 14 then consists of a non-metallic material, such as plastic, so as not to impede inductive coupling for charging. When the food thermometer 1, 8 is inserted into the housing 14 of the charging tray, the food thermometer is indirectly held by the magnetic holder 30 for charging.

Such a magnetic holder may also be provided directly for the food thermometer 1, 8.

A food thermometer in the sense of the present disclosure is not designed to be able to measure very low temperatures such as, for example, temperatures significantly below sub-zero temperatures as are reached in household freezers. Thus, a food thermometer in the sense of the present disclosure is not designed to measure temperatures lower than −70° C. In principle, a food thermometer in the sense of the present disclosure is designed so that it cannot measure temperatures below −50° C. because food is generally produced with a supply of heat and very low temperatures are only applied for freezing a food.

A food thermometer in the sense of the present disclosure can withstand a steam atmosphere. A food thermometer is therefore generally encapsulated in a waterproof manner. A food thermometer in the sense of the present disclosure is resistant to common ingredients of a food, such as acid of lemons or vinegar.

1. A food thermometer comprising
a temperature sensor,
a rechargeable battery, and
a coil through which the battery can be inductively charged.

2. The food thermometer of claim 1, further comprising an elongated, liquid-tight container having an opening at one end face, wherein the opening is closed in a liquid-tight manner by a cap.

3. The food thermometer of claim 2, wherein the cap is connected to the container in a materially bonded manner.

4. The food thermometer of claim 3, the coil is arranged at the bottom of the cap.

5. The food thermometer of claim 2, the container consists of metal and the cap consists of plastic.

6. The food thermometer of claim 1, wherein the food thermometer has a pointed end, and wherein the battery and a temperature sensor are arranged at the pointed end.

7. A charger for a food thermometer, the charger comprising
a coil for inductively charging the food thermometer, and
an elongated receptacle providing means for receiving and charging the food thermometer and/or a holder by which the food thermometer can be held for charging.

8. The charger of claim 7, wherein the shape of the food thermometer is adapted to the shape of the elongated receptacle in such a way that the food thermometer can be received by the elongated receptacle only in a predetermined location and orientation relative to the coil such that the food thermometer can be charged.

9. The charger of claim 7, wherein the charger is a charging tray with an elongated container.

10. The charger of claim 9, wherein the charging tray comprises the coil in an end side of the elongated container for charging the food thermometer.

11. The charger of claim 9, wherein the charging tray comprises a battery for charging the food thermometer.

12. The charger of claim 11, wherein the charging tray comprises a second coilconfigured to charge the battery of the charging tray.

13. The charger of claim 12, wherein the second coil is arranged in the bottom of the container of the charging tray.

14. The charger of claim 8, wherein the charger is a food processor comprising a stand part, a vessel insertable into the stand part, a mixing and/or cutting tool, and a motor as a drive for the mixing and/or cutting tool.

15. The charger of claim 14, wherein the food processor comprises a recess (25, 29) for one of a charging tray shaped to receive the food thermometer or shaped to receive the food thermometer directly.

16. The food thermometer of claim 2, wherein the food thermometer has a pointed end, and wherein the battery and a temperature sensor are arranged at the pointed end.

17. The charger of claim 8, wherein the charger is a charging tray with an elongated container.

18. The charger of claim 10, wherein the charging tray comprises a battery for charging the food thermometer.
